(19) United States
(12) Patent Application Publication
(10) Pub. No.: US 2008/0127114 A1
(43) Pub. Date: May 29, 2008

(54) Framework for stealth dynamic coarse and fine-grained malware analysis

(76) Inventor: Amit Vasudevan, Pittsburgh, PA (US)

Correspondence Address: TY UNG, 16830 VENTURA BLVD., SUITE 360, ENCINO, CA, 91436, US

(21) Appl. No.: 11/998,347

(22) Filed: Nov. 28, 2007

Related U.S. Application Data
(60) Provisional application No. 60/861,621, filed on Nov. 28, 2006.

(51) Int. Cl. G06F 9/44

(52) U.S. Cl. 717/129

(57) ABSTRACT

A framework and method for creating malware analysis tools for dynamic and stealth coarse- and fine-grained malware analysis is provided. In one embodiment a method stalls the execution of a desired code on any form of access to memory or other devices. This can be used to monitor the behavior of the malware with respect to the system at a high level. Upon identification of a high level access, another method can be employed in order to decompose a desired range of code into its individual instructions as they execute thereby revealing the inner structure of the malware as it executes. Since the framework does not employ any processor debugging features, and its methods are self-resilient and completely invisible to the executing code, malware that employ any form of anti-debugging and/or anti-analysis strategy including using framework methods can be easily and effectively analyzed.

### RELATED APPLICATIONS

The present application claims priority to U.S. provisional patent application, Ser. No. 60/861,621, filed Nov. 28, 2006, the disclosure of which is incorporated by reference herein and for which benefit of the priority date is hereby claimed.

### FIELD OF THE INVENTION

The present invention relates to computing devices and, more particularly, to using computer devices to analyze malware.

### BACKGROUND OF THE INVENTION

As more and more computing devices such as personal computers, personal digital assistants, cellular telephones etc. are interconnected through various networks such as the Internet, computing device security has become increasingly more important. In particular, security against computing device external attacks from malware has become increasingly more important. Malware, for purposes of the present discussion, is defined as a software source of an unwanted computer attack. As such, those skilled in the art will appreciate that malware includes, but is not limited to computer viruses, trojan horses, rootkits, worms, abuse/misuse of legitimate computer system functions and the like. The primary defense against malware today is anti-virus software.

The typical manner in which current anti-virus software operates to protect computring devices from malware is as follows. An anti-virus software provider use a signature database along with the anti-virus software. A signature uniquely identifies a malware. The anti-virus software then scans the computing device data comparing signatures within its database to find and remove a malware. Obtaining the signature for a malware requires an anti-virus software provider to examine/analyze the malware. However, recent malware are showing trends which incorporate heavy anti-analysis strategies against the tools currently used for the analysis process thereby slowing down this analysis process resulting in the increase in the period of time from when a new malware is found to the release of its signature. Unfortunately, the period of time may range from several days to weeks depending upon the complexity of the anti-analysis techniques within which time the malware usually accomplishes a majority of its attacks.

Current tools used for malware analysis can be broadly categorized into static and dynamic approaches. Static approaches are primarily used for fine-grained malware analysis and analyze malware without executing them. At the heart, current static tools employ some form of a disassembler in order to construct a control flow of a given executable. In spite of some beneficial properties of static tools, there are many limitations. The main limitation of static approaches is that the analyzed code need not be the one that is actually run. This is particularly true of malware that employ advanced techniques such as self-modification. Also static approaches face the problem of indirect branches and code obfuscations.

Dynamic approaches on the other hand analyze malware during runtime ensuring that the analyzed code is the one that is actually run. Dynamic tools can be used for both coarse- and fine-grained malware analysis. Current coarse grained dynamic tools employ at the heart some form of code modification in order to execute a replacement code when the original code is invoked (e.g software breakpoint or branch instruction). This is clearly unsuitable as most if not all malware employ some form of self-checking or self-modification. Hardware breakpoints currently is the only coarse-grained aid that does not modify any code, however they are detected and countered by recent malware as they employ certain processor registers which can be checked and manipulated by malware. Further, current processors only provide a very limited number of hardware breakpoints to be active simultaneously which is a very serious limitation in order to observe the behavior of a malware. Current fine-grained dynamic approaches use either a virtual machine based approach or hardware based single-stepping. Hardware based single-stepping is defeated by many recent malware which use single-stepping for their own functionality thereby effectively thwarting them. Current virtual machine approaches isolate the executing code and are easily detected and countered since the isolation is far from perfect. Many recent malware use timing techniques in order to detect virtual machines as they employ dynamic translation which leads to more execution time than in normal execution. Also these virtual machines are used more to contain the malware than aid in fine-grained analysis and use the underlying processor breakpoint and single-stepping for fine-grained analysis.

In the light of the above-identified problems, it would be beneficial to malware analysts, to have a framework that allows them to analyze malware in both coarse- and fine-grained fashion at runtime such that they do not need to worry about the malware detecting the analysis framework in any fashion and can quickly and effectively analyze pertinent malware code in order to obtain a signature as soon as possible. The present invention is directed to providing such software.

### SUMMARY OF THE INVENTION

In accordance with the present invention, there is provided a framework, method, and computer readable medium for creating malware analysis tools for dynamic and stealth behavioural and structural malware analysis is provided. In one embodiment a method stalls the execution of a desired code on any form of access to memory or other devices. This can be used to monitor the behavior of the malware with respect to the system at a high level. Upon identification of a high level access, another method can be employed in order to decompose a desired range of code into its individual instructions as they execute thereby revealing the inner structure of the malware. Since the framework does not employ any processor debugging features, and its methods are self-resilient and completely invisible to the executing code, malware that employ any form of anti-debugging and/or anti-analysis strategy including using framework methods can be easily analyzed.

This summary is provided to introduce a selection of concepts in a simplified form that are further described below in the Detailed Description. This summary is not intended to identify key features of the claimed subject matter, nor is it intended to be used as an aid in determining the scope of the claimed subject matter.

### BRIEF DESCRIPTION OF THE DRAWINGS

A complete understanding of the present invention may be obtained by reference to the accompanying drawings, when considered in conjunction with the subsequent, detailed description, in which:

FIG. 1 is an is a high-level block diagram that illustrates selected components of a stealth malware analysis framework according to some embodiments;

FIG. 2 is a flow diagram that illustrates the processing of the stealth breakpoint component, according to some embodiments;

FIG. 3 is a flow diagram that illustrates the processing of the stealth breakpoint persistence component, according to some embodiments;

FIG. 4 is a flow diagram that illustrates the processing of a replacement function that may be used to monitor a function within a standard library, component or the host operating environment to monitor malware behavior at a high level;

FIG. 5 is a flow diagram that illustrates the processing of the stealth single-step component, according to some embodiments;

FIG. 6 is a flow diagram that illustrates the processing of the stealth localized-execution component, according to some embodiments;

FIG. 7 is a flow diagram that illustrates the processing of the block create component, according to some embodiments;

FIG. 8 is a flow diagram that illustrates the processing of the block execute component, according to some embodiments;

FIG. 9 is a flow diagram that illustrates the processing of the stealth localized-execution stub, according to some embodiments;

FIG. 10 is a table of example entries of instructions and attributes for stealth localized-execution stubs;

FIG. 11 is a flow diagram that illustrates the processing of the execution control component, according to some embodiments;

FIG. 12 is a flow diagram that illustrates the processing of the entry stub, according to some embodiments;

FIG. 13 is a flow diagram that illustrates the processing of the exit stub, according to some embodiments;

FIG. 14 is a high-level block diagram that illustrates selected components of the local interface component according to some embodiments; and

FIG. 15 is a high-level block diagram that illustrates selected components of the remote interface component according to some embodiments.

For purposes of clarity and brevity, like elements and components will bear the same designations and numbering throughout the Figures.

### DESCRIPTION OF THE PREFERRED EMBODIMENT

A framework and method for creating malware analysis tools for dynamic and stealth coarse- and fine-grained malware analysis is provided.

In some embodiments the stealth malware analysis framework executes on a computer system or device, such as a desktop, computer system, a server, firewall, domain controller etc. and provides the capability to stall the execution of instructions on the computer system on a desired condition without altering processor registers or program (including malware) code/data. For example, an analyst might wish for execution to stop when a particular range of memory is written to. This range of memory might have been allocated by a malware in order to decrypt its code into. Thus by stalling execution on a write to the memory range, an analyst can obtain the decrypted code. In effect, the framework stops code execution for a specified condition, allowing an analyst to decide the next course of action during analysis, for example, choosing to modify the processor register and/or memory and resume execution or to resume execution from a completely different point.

In some embodiments the stealth malware analysis framework provides the ability to monitor, generate events on and change the instructions comprising the malware in real-time without using any processor registers or changes to target code/data. For example, the stealth malware analysis framework can dynamically monitor a desired range of code executing at the unprivileged level and generate an event on an interrupt invocation. This generated event can then be used for further investigation. For example, the analyst may wish to monitor all the instructions from the start of the interrupt generated to the interrupt handler returning. This sequence of instruction can then be used to analyze the working of the malware at a very fine level. For example, the generated instruction sequences can be analyzed to may be reveal a decryption function within the privileged level which decrypts code at the unprivileged level. When applied across the malware code regions, an analyst can quickly identify the inner workings of a malware and analyze pertinent areas in order to obtain an identification.

In some embodiments the stealth malware analysis framework provides the ability to monitor invocations to functions within static and dynamically loaded modules as well as functions within the operating environment without overwriting the target function or any portion of memory. This may be referred to as a coarse-grained analysis since monitoring takes place at a functional level than at an instruction level. For example, the stealth malware analysis framework can monitor invocations to the operating environment functions which allocate memory in either privileged or unprivileged levels. This can be used for further finer investigation. For example, the allocated memory areas can then be monitored for executes. Coarse-grained analysis is also useful in building a behavioral model for the malware and document its external manifestations. For example, invocations to the filesystem and configuration (registry) can be monitored to understand the files and configuration entries created by the malware. Such information provide starting points for finer investigations. For example, a registry entry creation that ties a specific kernel mode driver at bootup suggests investigation into the kernel-mode driver itself.

In some embodiments the stealth malware analysis framework provides the ability to to obtain control before any other executing code at all times during the period of execution. For example, a malware can install its own exception handling routine in the privileged level, in order to perform a part of its functionality. When the exception triggers, however, the malware analysis framework is the first to get control. This ability can be used to analyze complex behaviors that occur within a malware. For example, a malware might use a privileged interrupt in order to perform control transfer or decryption. The malware analysis framework upon gaining control the framework will be the first to obtain control when the exception triggers and can then allow an analyst to perform further finer investigations on the exception handling routine.

In some embodiments the stealth malware analysis framework provides the ability to monitor all possible entry and exit points which can result in a privilege level change so that the framework can always remain in control regardless of the operating privilege level. This may be used in order to analyze malware that operate using both unprivileged and privileged components.

In some embodiments the stealth malware analysis framework provides the ability to remain completely stealth in both unprivileged and privileged levels of execution. In other words, an executing code stream cannot positively determine if the framework is running. For example, a malware running in the unprivileged mode can scan the memory in order to determine the framework code. Once the malware detects the framework it may purposely try and evade analysis by executing code that would normally never be executed. A malware could also use the privileged mode to execute code that can try to detect the presence of an analysis framework. It may scan critical processor structures such as interrupts or change permissions of memory regions etc. However, the malware analysis framework is resilient to such and any other form of detection and countering.

In some embodiments the stealth malware analysis framework provides the ability to to emulate or directly execute a single instruction under supervision without using any processor dependent facility. This is useful for executing instructions one at a time. For example, a malware analyst could set a stealth breakpoint on a memory range which triggers when something executes there. Upon breakpoint triggering the malware analyst may execute one instruction at a time in order to examine the effects of the instructions in finer detail.

In some embodiments the stealth malware analysis framework provides the ability for the stealth malware analysis framework to interact with the malware analyst and enables the analyst to tailor the framework to suit his/her needs. For example, the malware analysts may wish to see a visual representation of the instructions as they are being monitored by the malware analysis framework, and may wish to stop the monitoring at a particular point or simply set certain configuration parameters in the framework. Further this interaction is achieved without relying on the host operating environment. For example, a malware may modify a network driver exception handler in order to intercept a network packet. If the same network driver is used for interaction purposes, it would be required to run the entire exception handler within a monitored environment and increase the complexity of the framework. By not relying on the host environment and directly accessing the devices required for the interaction, the malware analysis framework is able to allow a malware to modify virtually any aspect of the host environment.

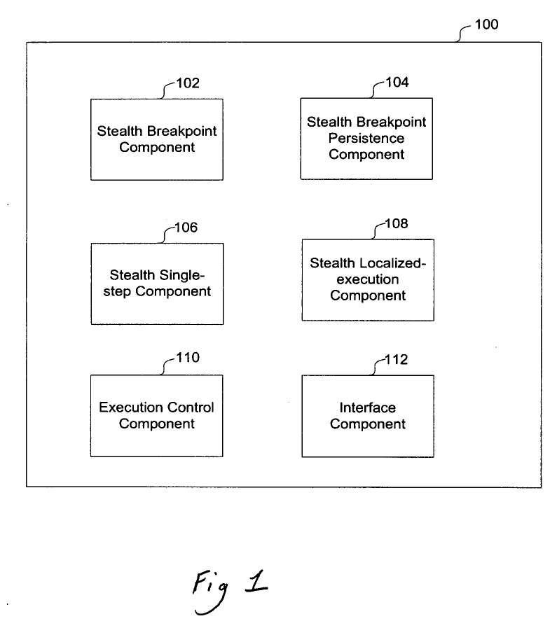

FIG. 1 is a high-level block diagram that illustrates selected components of a stealth malware analysis framework 100 according to some embodiments. The stealth malware analysis framework comprises a stealth breakpoint component 102, a stealth breakpoint persistence component 104, a stealth single-step component 106, a stealth localized-execution component 108, a execution control component 110 and a interface component 112.

The stealth breakpoint component provides the ability to stop the execution of instructions on the current processor without any modification to processor registers or the target code/data. The stealth breakpoint component can stop the execution of instructions when there is access to a particular range of memory for read, write or execute. It can also stop execution of instructions when there is access to a memory mapped I/O port or legacy I/O port. Further, it can stop execution in cases where the above situations occur in either a privileged or an unprivilged level. These memory ranges/i/o ports are termed “stealth breakpoinats” and is said to trigger when there is access to them. Every stealth breakpoint has an associated event handler, a routine to which control is transferred when the stealth breakpoint triggers. The event handler can monitor and/or alter the system state if desired. In some embodiments the stealth breakpoint component provides the ability to monitor and alter the semantics of invocations to functions within static and dynamically loaded modules as well as functions within the operating environment. It allows for a replacement function to be invoked: before the original function is invoked, at any point within the original function or after the original function has finished its processing. It can provide this ability for functions that are executing in either user or kernel-mode.

The stealth breakpoint persistence component provides the ability for a stealth breakpoint to persist in the system. A stealth breakpoint can be active or inactive. and can be one shot (triggered once), persistent (triggered always) or selectively persistent (triggered selectively). In some embodiments, the stealth breakpoint persistence component allows a replacement function to execute the original function from within itself. This is very useful in situations where the replacement function only needs to monitor the incoming and outgoing results of the function or when it needs to perform the semantics of the original function. In both cases, the replacement function can do the necessary supplementary processing while using the original function to perform most of the functionality.

The stealth single-step component provides the ability to execute a single instruction either directly using the processor or by emulating its semantics without using any system provided debugging features in a way such that the effect on the system is exactly the same as it would be if the processor would have executed it during normal execution. It emulates all branch and privileged instructions while executing all other instructions directly on the processor. Further, the stealth single-step component can handle any exception including system generated single-step exceptions. The direct instruction execution is performed in a framework specific memory area with the instruction operands relocated appropriately.

The stealth localized-executions component provides the ability to monitor and change the instructions comprising the malware in real-time without using any processor registers or changes to target code/data and without the code noticing the effects. It is able to do so even in the presence of self-modifying, self-checking and obfuscating coding techniques. Further, it can provide this ability either in privileged or unprivileged mode. The monitoring starts from a overlay point and ends at a release point, the region of code that an analyst wishes to dynamically monitor/change instructions for. The stealth localized-executions component creates blocks of instructions which are then executed one at a time to mimic the execution of the target code stream. These blocks are executed at the unprivileged level and at native speed in order to improve performance and to retain control over the executing instructions. The stealth localized-executions component gets control after the block has executed, dynamically generates a new block and the cycle repeats until the release point is reached. The blocks are created in a framework local cache and hence do not involve any modifications to the target code-stream. Further, every block terminates at a conditional ensuring that the component is able to accurately generate the next block in presence of obfuscating code. In some embodiments the stealth localized-executions component provides the ability to monitor the instructions for use by the execution control component and by the stealth breakpoint component.

The execution control component provides the ability for the stealth malware analysis framework to obtain control before any other executing code at all times during execution. Further, the execution control component also provides the ability for the stealth malware analysis framework to always be in control of the executing code whether they are executing in unprivileged or privileged level. The execution control component uses substitute memory regions for all critical structures that are employed by the system. Thus any access to these critical structures are directed at the substitute memory regions rather than the original. This ensures that the framework is the first to get control since the processor will always use the original memory regions for the critical structures for its operation. The execution control component also provides the capability to monitors all possible entry and exit points which can result in a privilege level change so that the framework can always remain in control regardless of the operating privilege level. Such critical structures include GDT, LDT, IDT and processor Machine Specific Registers. In some embodiments the execution control component tracks changes to the original code stream which is then used by the stealth localized-executions component to recreate blocks for modified code in order to support self-modification.

The interface component provides the ability for the malware analysis framework to interact with the malware analyst and allows a malware analyst to tailor the framework to suit his/her needs. The interface component always exists on the system where the code is being analyzed and may exist on another computer system. Further the interface component can interact with the user on the system where the code is being analyzed or on another computer system. If interacting with the user on the same computer system the interface component makes use of a dedicated input and output driver for devices (such as keyboard, mice and display device) in order to interact with the analyst. This ensures that the framework is not affected by any modifications that a malware could do to the host environment. However, if the interface component interacts with the user on on another computer system, it makes use of a communications link such as local area network, serial cable etc.

In a typical deployment of the stealth malware analysis framework, the various components of the stealth malware analysis framework are all deployed over a multiple number of computer systems and devices. For example, to analyze how a malware functions on a host, deployment on a single computer system and devices might be sufficient. However, to analyze the malware propagation over a network and infection, deployment might be needed on two or more such pairs of computer systems and devices. The malware analysis framework can be deployed at anytime during the operation of the operating environment, once a dual mode of operation is in effect (privileged vs unprivileged). One skilled in the art may appreciate that the malware analysis framework can be deployed in other ways. For example, the framework components can be deployed on a single computer system and devices whereas the framework interface component can be deployed on another system. Further, multiple such single systems comprising of the framework components can all interact with a single system with the framework interface component.

The computing device on which the stealth malware analysis framework is implemented may include a CPU, memory, input devices (e.g keyboard and pointing devices), output devices (eg. display devices) and storage devices (eg. disk drives). The memory and storage devices are computer readable media that may contain instructions that implement the system. In addition the data structures and message structures may be stored or transmitted via a data transmission medium, such as internet, local area network, wide area network, a point-to-point connection, cellular network etc.

Embodiments of the framework may be implemented in various operating environments which includes personal computers, server computers, hand-held or laptop devices, multiprocessor systems, microprocessor based systems, network PCs, minicomputers, mainframe computers, network devices, distributed computing environments that include any of the above systems or devices and so on. The computer systems maybe cell phones, personal digital assistants, smart phones, personal computers and so on.

The framework may be described in the general context of computer executable instructions, such as program modules, executed by one or more computers or other devices. Generally program modules include, routines, programs, objects, components, data structures and so on that perform particular tasks or implement abstract data types. Typically, the functionality of the program modules may be combined or distributed as desired in various embodiments.

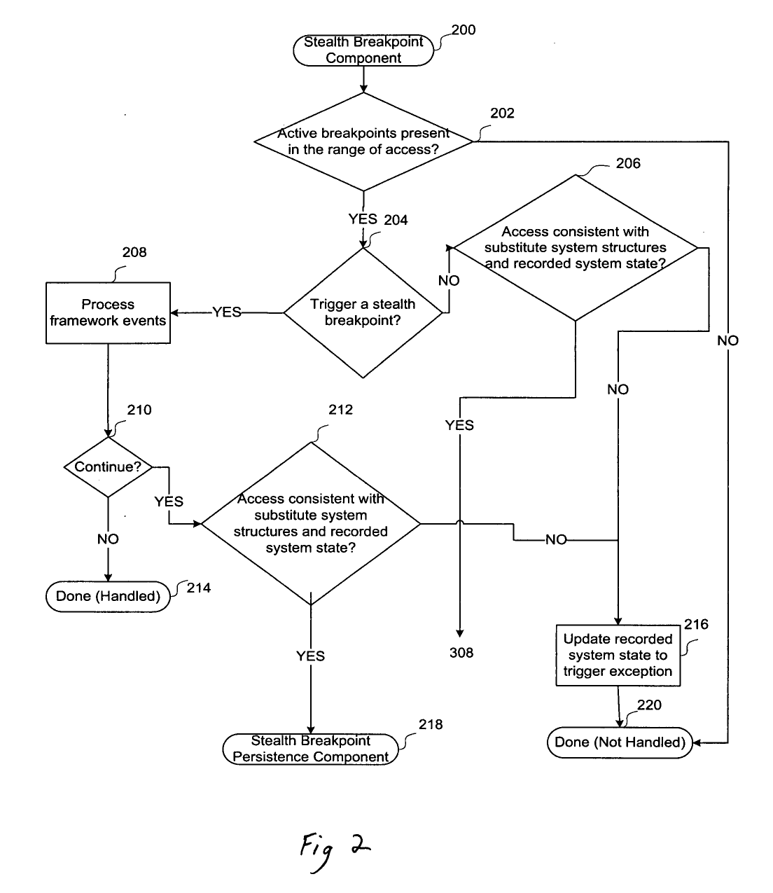

FIG. 2 is a flow diagram that illustrates the processing of the stealth breakpoint component, according to some embodiments. By way of example, the stealth breakpoint component can be invoked by the execution control component due to an exception in the system. For example, when a stealth breakpoint is initially deployed, the stealth breakpoint component may set the memory page attribute corresponding to the breakpoint range to trigger a page-fault exception on access to the memory region. Similarly, the stealth breakpoint component on IA-32 (and compatible) processors may set the I/O Bitmap attribute corresponding to the legacy I/O port to trigger a general-protection fault exception on access to the port. In block 202 the stealth breakpoint component checks for any active stealth breakpoint in the range of access. For example, for a memory breakpoint, the stealth breakpoint component can check in its recorded breakpoint list to see if any breakpoint falls on the memory page causing the page-fault exception. Similarly, for a legacy I/O breakpoint, the stealth breakpoint component can check in its recorded breakpoint list to see if any port is marked in the I/O Bitmap structure. In one embodiment, the stealth breakpoint framework may store all active breakpoints in a circular data store in memory. If there are no active stealth breakpoints in the range of access, the stealth breakpoint component goes to block 220 and returns indicating that the fault was not due to a stealth breakpoint. If there are active stealth breakpoints in the range of access, the stealth breakpoint component in block 204 determines if a stealth breakpoint needs to be triggered. For example, for a memory breakpoint, the stealth breakpoint component disassembles the instruction causing the page-fault and computes its effective address to determine if it was a read, write or execute. Similarly, for a legacy I/O breakpoint, the stealth breakpoint component disassembles the instruction causing the general protection fault to determine the port and the type of access read or write. If a stealth breakpoint needs to be triggered, then in block 208, the stealth breakpoint processes any events. For example, the stealth breakpoint component can invoke an analyst supplied event handler to handle the breakpoint. If a stealth breakpoint does not need to be triggered, then in block 206 the stealth breakpoint component determines if the access is consistent with the substitute structures or the recorded system state and if so transfers control to block 308 of the stealth breakpoint persistence component. For example, for a read memory breakpoint, if a write is attempted and the substitute memory page attribute is both read and write, then the write must go through. If the access is not consistent with the substitute structures or the recorded system state, then in block 216 the stealth breakpoint component updates the recorded system state to generate an exception to the appropriate handler in the substitute system structures and goes to block 220 and returns indicating that the fault was not due to a stealth breakpoint. For example, for a memory breakpoint, the substitute memory page attribute might be set to read only whereas if a write is performed, the page fault handler in the substitute system structure needs to be invoked. Similarly, the recorded system state might have a processor hardware breakpoint set on the access in which case the breakpoint handler in the substitute system structure needs to be invoked. After processing any events in block 208, the stealth breakpoint component in block 210 checks to see if the event handler has handled the breakpoint. If so, it goes to block 214 and returns indicating that the breakpoint was handled. If the event handler wishes to continue, the stealth breakpoint component in block 212 determines if the access is consistent with the substitute structures or recorded system state. If not it does the processing from block 216 as previously described. If the access is consistent, the stealth breakpoint component in block 218 transfers control to the stealth breakpoint persistence component to handle stealth breakpoint persistence and returns.

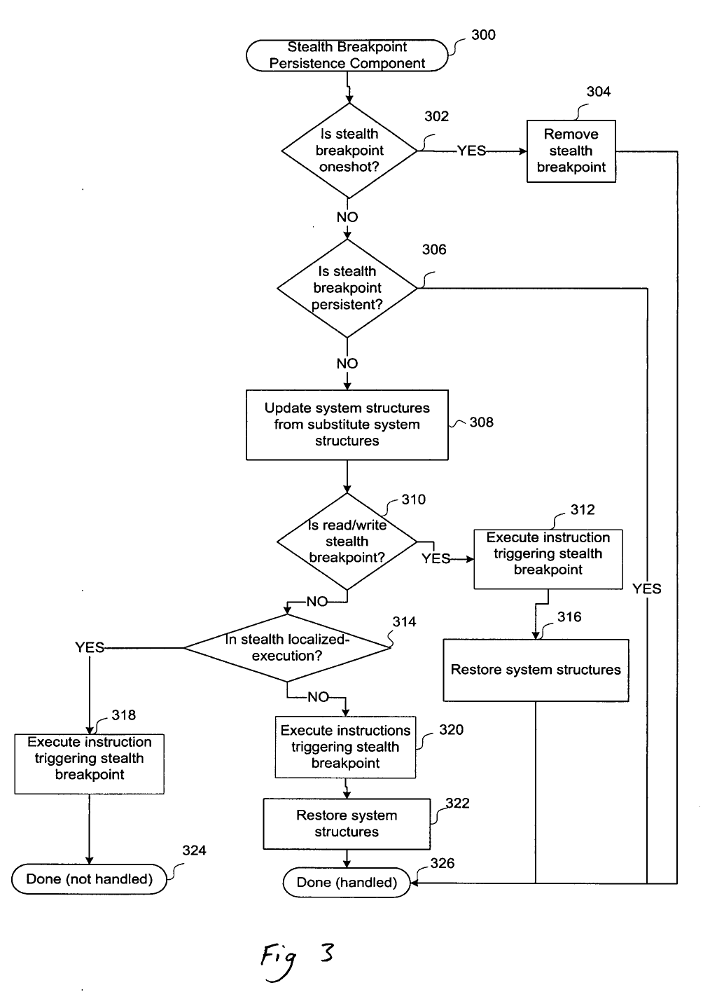

FIG. 3 is a flow diagram that illustrates the processing of the stealth breakpoint persistence component, according to some embodiments. The stealth breakpoint persistence component can be invoked by the stealth breakpoint component in order to handle breakpoint persistence. In block 302 the stealth breakpoint persistence component checks to see if the stealth breakpoint is a one shot. If so, it removes the breakpoint from the recorded breakpoint list in block 304 and returns via block 326 signifying that the persistence was handled. In one embodiment, the stealth breakpoint framework may store all active breakpoints in a circular data store in memory. If the stealth breakpoint was not a one shot, in block 306 the stealth breakpoint persistence component checks to see if the stealth breakpoint is persistent. If so, it returns via block 326 signifying that the persistence was handled. If the stealth breakpoint is not persistent, in block 308 the stealth breakpoint persistence component sets up the system structures to that of the attributes in the substitute structures. In block 310 the stealth breakpoint persistence component then checks to see if it is a read or write access. If so it executes the instruction causing the breakpoint in block 312 and sets the system structures back to trigger future breakpoints in block 316 and returns via block 326 signifying that the persistence was handled. For example, a IO instruction might access a IO port to read data. If a stealth breakpoint was set on the port, it may be configured to be selectively persistent so that upon return from breakpoint triggering the same instruction executes until a specified condition is met. In this case it might be a specified data that is read. If in block 310 the stealth breakpoint persistence component determines that the access is for execute, it checks to see in block 314 if the stealth localized-execution component is currently executing. If so, it executes the instruction causing the breakpoint in block 318 and returns via block 324. If not, it invokes the stealth localized-execution component to execute all the instructions on the memory page containing the breakpoint in block 320 and configures it to return when execution goes out of the memory page. In block 322 the stealth breakpoint persistence component sets the system structures to trigger future breakpoints and returns via block 326 signifying that persistence was handled. For example, when an execute memory breakpoint is set on a memory page and a location that is not a stealth breakpoint is accessed within the memory page for execute, this mechanism will prevent recursive triggering of breakpoints.

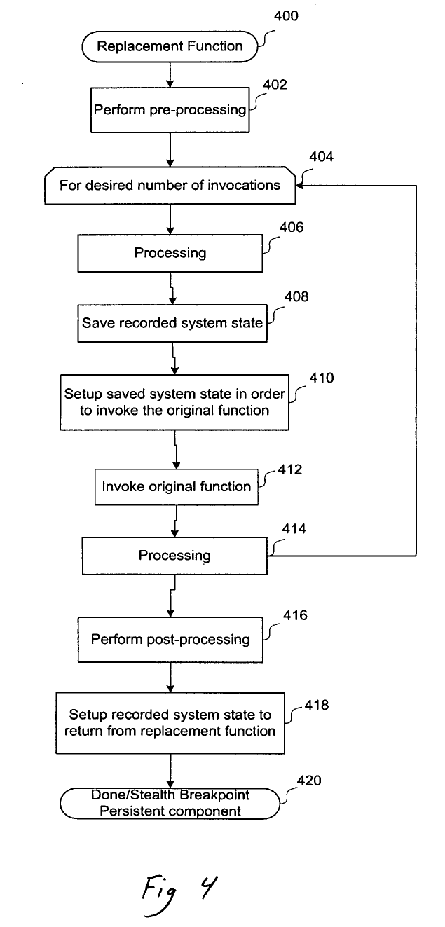

FIG. 4 is a flow diagram that illustrates the processing of a replacement function that may be used to monitor a function within a standard library, component or the host operating environment to monitor malware behavior at a high level. By way of example, the replacement function may be invoked due to a stealth breakpoint on memory execute at the address of the target function. When the execute breakpoint triggers the replacement function gets control and in block 402 does any necessary pre-processing. For example, if the replacement function is for a function responsible for creating processes, this might include recording the process file name. In block 404 the replacement function can then invoke the original function as many times as desired. For example, the replacement function can create 3 different processes. For each invocation of the original function the replacement function in block 406 performs any pre processing. It then saves the original system state to a local copy in block 408 and sets up the local copy of the system state to invoke the original function in block 410. For example, this might involve pushing the return address on the stack and establishing a call frame. It then invokes the stealth breakpoint persistence component to execute the original function without retriggering the execute breakpoint in block 412 and performs necessary post processing in block 414. In block 416 the replacement function performs any changes to the return value of the original function and in block 418 sets up the recorded system state to return from the replacement function. For example, the replacement function can utilize a combination of return values from the number of invocations to the original function or may choose to chain to the original function and return its return value in block 420.

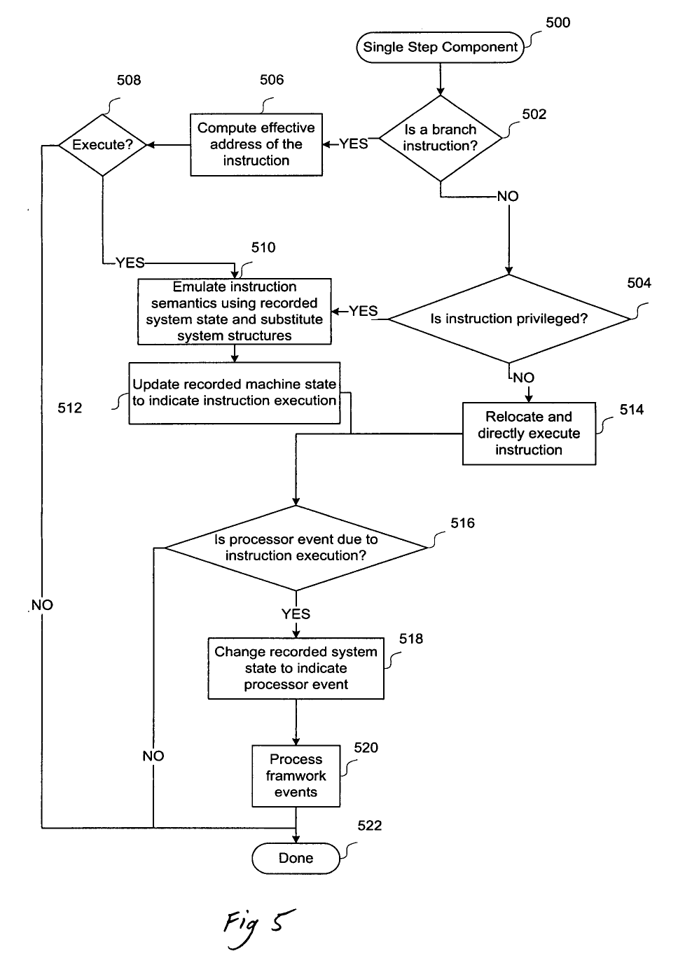

FIG. 5 is a flow diagram that illustrates the processing of the stealth single-step component, according to some embodiments. By way of example, the stealth single-step component can be invoked by the stealth breakpoint persistence component to step over an instruction and replace the breakpoint. In block 502, the stealth single-step component determines if the instruction is a branch instruction. For example, a dissassembler can be used to obtain the opcode of the instruction which is then checked with the opcodes of the underlying processor. If the single-step component determines the instruction is a branch it transfers control to block 506 else it transfers control to block 504. In block 506 the stealth single-step component computes the effective address of the instruction. For example, a disassembler can be used to obtain the operands of the instruction and the actual value is then obtained from the recorded system state to obtain the effective address at that point in instruction execution. Then the stealth single-step component in block 508 checks if the instruction has to be single-stepped or just evaluated. If the instruction need not be single-stepped the stealth single-step component returns the effective address calculated in block 522, else it transfers control to block 55. In block 504 the stealth single-step component checks if the instruction is a privileged instruction or uses any privileged registers. For example, disassembler can be used for this purpose as described previously. If so, it transfers control to block 510, else in block 514, it relocates and directly executes the instruction in the system. For example, the instruction can be copied to a framework memory area, its operands adjusted for the difference in the original location and the memory area and executed via a exit stub component and followed by a entry stub component to transfer control back into the framework. The single-step component then transfers control to block 516. In block 55 the stealth single-step component emulates the instruction semantics using the recorded system state and substitute memory structures and in block 512 updates the recorded system state with the result of the instruction emulation. For example, a cycle accurate instruction emulator can be used for this purpose. The stealth single-step component then transfers control to block 516. In block 516, the stealth single-step component checks for any processor events that the instruction execution might have triggered. If not, it returns via block 522 else it transfers control to block 518 where the stealth single-step component changes the recorded machine state to incorporate the processor event. For example, if the instruction execution was done and the system state had single-stepping turned on, the single-step handler frame is pushed on the stack for invocation. In block 520, the stealth single-step component processes any framework events. For example, a event handler might use this event to single-step code and to observe the resulting system state. Finally, the stealth single-step component finishes its processing and returns via block 522.

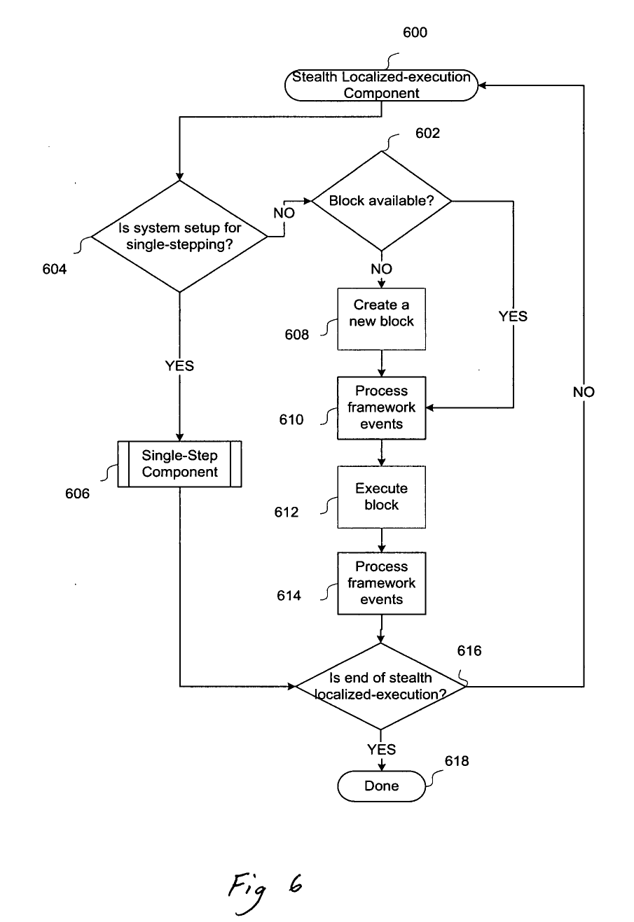

FIG. 6 is a flow diagram that illustrates the processing of the stealth localized-execution component, according to some embodiments. By way of example, the stealth localized-execution component can be invoked by the execution control component in order to execute privileged code in an unprivileged level. In block 604, the stealth localized-execution component checks to see if single-stepping is turned on in the recorded system state. For example, a processor trap flag can be checked in the recorded system state which signifies single-stepping. If single-stepping is turned on in the recorded system state, the stealth localized-execution component in block 606 single steps the current instruction else it transfers control to block 602. For example, the stealth single-step component can be invoked to do the processing. The stealth localized-execution component then transfers control to block 616. In block 602, the stealth localized-execution component checks to see if a block already exists for the memory address of the current instruction. For example, the recorded system state can be used to find the memory address of the current instruction and a data store in memory can be used to store previously constructed blocks. If not, it invokes the block create component to create a new block starting from the current instruction and then transfers control to block 610 else it transfers control to block 610. In block 610, the stealth localized-execution component processes any framework events. For example, a event handler may wish to log and display the blocks that are being created before they are being executed. In block 612, the stealth localized-execution component executes the created block using the block execute component. Then in block 614 the stealth localized-execution engine processes any events that are post block execution and transfers control to block 616. For example, an event handler may wish to log the system state after a block has been executed. In block 616 the stealth localized-execution component determines to see if it should stop execution. For example, a end of range has been reached or an event handler could be invoked to check on a custom condition if the component should stop. Finally the stealth localized-execution components returns via block 618.

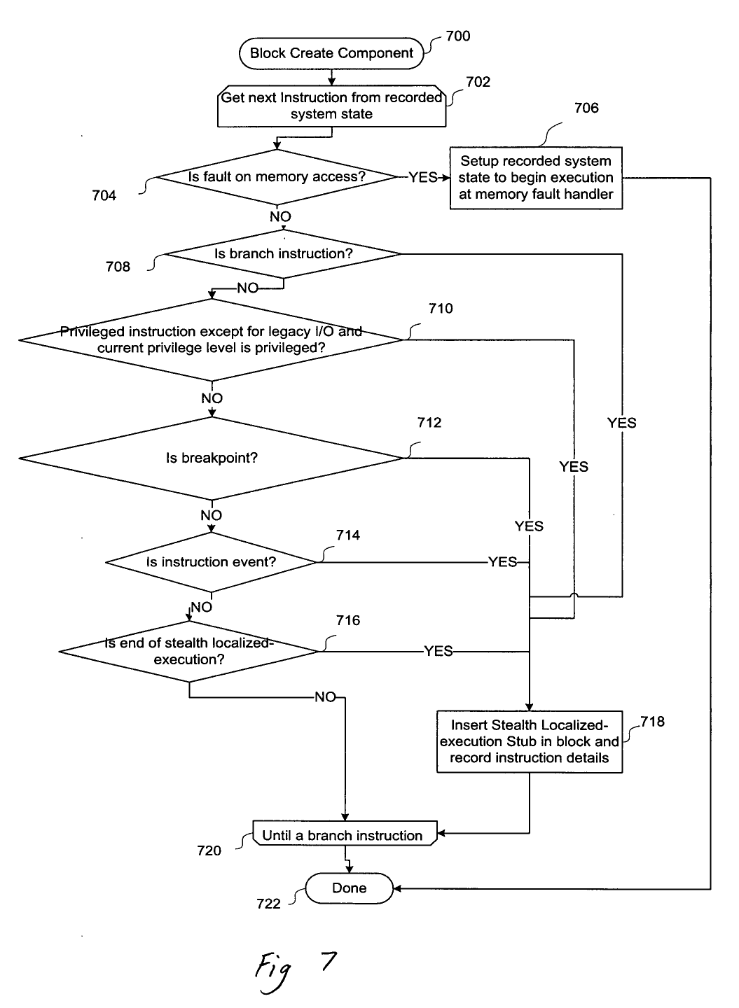

FIG. 7 is a flow diagram that illustrates the processing of the block create component, according to some embodiments. By way of example, the block create component can be invoked from the stealth localized-execution component. In block 702 the block create component obtains the next instruction from the recorded system state. For example, a disassembler can be used to obtain the instruction using the recorded system state. Then in block 704, the block create component checks if obtaining the instruction resulted in any exception generated. For example, the disassembler can indicate that it tried to read instruction from a memory location that was not readable. If the instruction resulted in any exception, in block 706 the block create component updates the recorded system state to signal the exception else it transfers control to block 708. For example, the exception handler frame can be pushed on the stack of the recorded system state to start executing the handler. The block create component then returns via block 722. In block 708 through 716 the block create component examines the type of instruction privileged, legacy I/O or memory address where a breakpoint is set, or an instruction that needs an event or a release point. For example, the opcode of the instruction can be used to determine the type of the instruction and a data store in memory can be used to see if the framework is configured to generate events on a particular instruction or to obtain the release point. If any of block 708 to 716 is true, then the block create component, in block 718 inserts a SLE Stub component into the block for those instructions and records the instruction details. In one embodiment, the instruction details can be recorded in a data store in memory. It then in block 720 checks to see if a branch instruction has been found and if so terminates the block and returns via block 722.

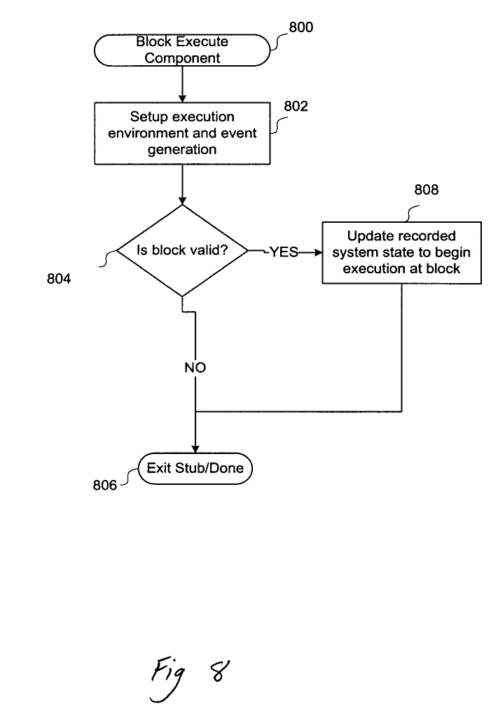

FIG. 8 is a flow diagram that illustrates the processing of the block execute component, according to some embodiments. By way of example, the block execute component can be invoked from the stealth localized-execution component. In block 802, the block execute component sets up the execution environment and event generation. For example, the execution environment can be an unprivileged execution mode and the event generation setup can be memory regions corresponding to the executing code as well as any other memory regions that are made inaccessible at the unprivileged level. In block 804, the block execute component checks if the block to be executed is valid and if not in block 806 restores the system state from the recorded system state and executes via the exit stub and ends processing via block 810 else it transfers control to block 808. In block 808, the block execute component updates the recorded system state to begin execution from the block and begins block execution via the exit stub component in block 806. Once the block has finished execution, the block execute component returns via block 810

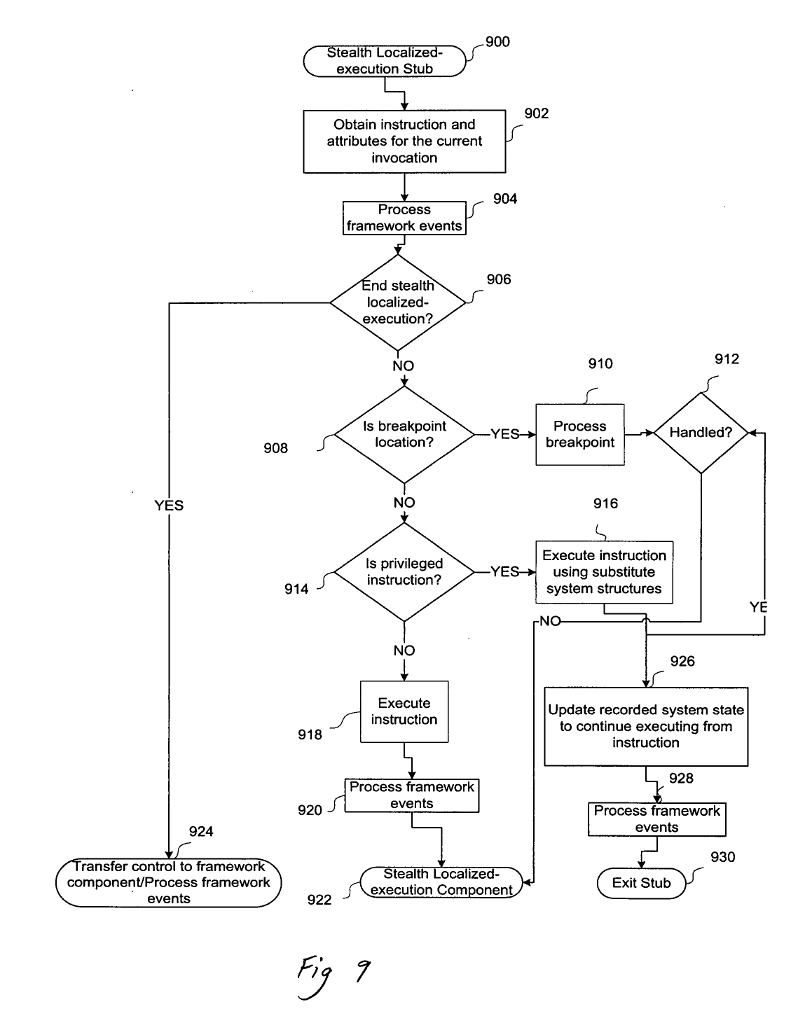

FIG. 9 is a flow diagram that illustrates the processing of the stealth localized-execution stub, according to some embodiments. By way of example, the stealth localized-execution stub can be invoked from the block during block execution by the block execution component. In block 902 the stealth localized-execution stub obtains the instruction and its attributes that it replaced in the block. For example, in one embodiment, a data store in memory can be used to store the instructions and attributes that are replaced with stealth localized-execution stubs. In block 904, the stealth localized-execution stub processes any framework events. For example, an event handler can be setup to generate event on a particular type of instruction such as move to a particular register etc. In block 906, the stealth localized-execution stub checks to see if stealth localized-executions should stop. For example, this can be a memory address that the framework was configured to stop sle at, or it can be an event handler that checks on a custom condition, such as change to an unprivileged level. If so the stealth localized-execution stub transfers control to a framework component that initiated the sle or an event handler which initiated the sle via block 924 else it transfers control to block 908. In block 908, the stealth localized-execution stub checks if the instruction triggers a breakpoint. For example, the same data store as described above can be used to determine if this a breakpoint. If so, the stealth localized-execution stub transfers control to the stealth breakpoint component in block 910 to handle the breakpoint,else it transfers control to block 914. Upon return from the stealth breakpoint component, the stealth localized-execution stub checks to see if the breakpoint was handled in block 912. If not, the stealth localized-execution stub continues sle via block 922, else it transfers control to block 926. In block 99, the stealth localized-execution stub checks to see if the instruction is a privileged instruction and if so executes the privileged instruction using substitute system structures in block 916. For example, the stealth single-stepping component can be used for this purpose. It then transfers control to block 926. If the instruction is not a privileged instruction, the stealth localized-execution stub in block 918 computes the next address to continue sle from. For example, the single-step component can be used for this purpose. The stealth localized-execution stub then processes any framework events in block 920. For example, an event handler can be setup to generate event on a particular instruction type, may handle the event and may wish to obtain control again after the instruction has executed. The stealth localized-execution stub then continues sle via block 922. In block 926, the stealth localized-execution stub updates the recorded system state to execute the next instruction, processes any framework events in block 928 and exits from sle via an exit stub in block 930.

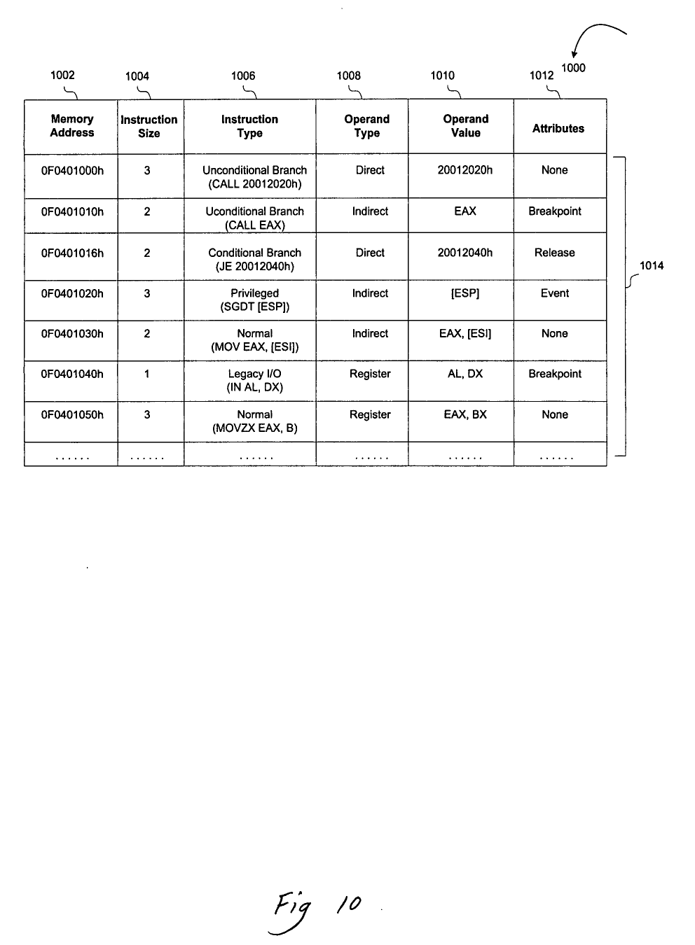

FIG. 10 illustrates a table 1000 of example entries of instructions and attributes for stealth localized-execution stubs. The table of example entries of instructions and attributes for stealth localized-execution stubs comprises one or more records 1014, and each record is shown comprising, by way of example, six fields including a memory address field 1002, instruction size field 1004, instruction type field 1006, operand type field 1008, operand value field 1010 and attributes field 1012. The memory address field specifies the original memory address of the instruction corresponding to its stealth localized-execution stub. The instruction size field specifies the size of the instruction in bytes in memory. The instruction type field specifies the type of the instruction: conditional branch, unconditional branch, privileged, legacy I/O and normal. The operand type field specifies the type of operand, either direct, register or indirect and the operand value field specifies the value of the operand. The operand value field is a constant for direct operands and is an expressing for indirect and register operands which is dynamically computed at runtime using the recorded system state. The attributes field specify extra attributes for the record such as it is a release point, breakpoint location or an event. By way of example, the record for the for the memory address 0F0401010h indicates that the stealth localized-execution stub was for an unconditional indirect branch instruction whose target address is determined by the register EAX and needs to be evaluated dynamically and is also a breakpoint location.

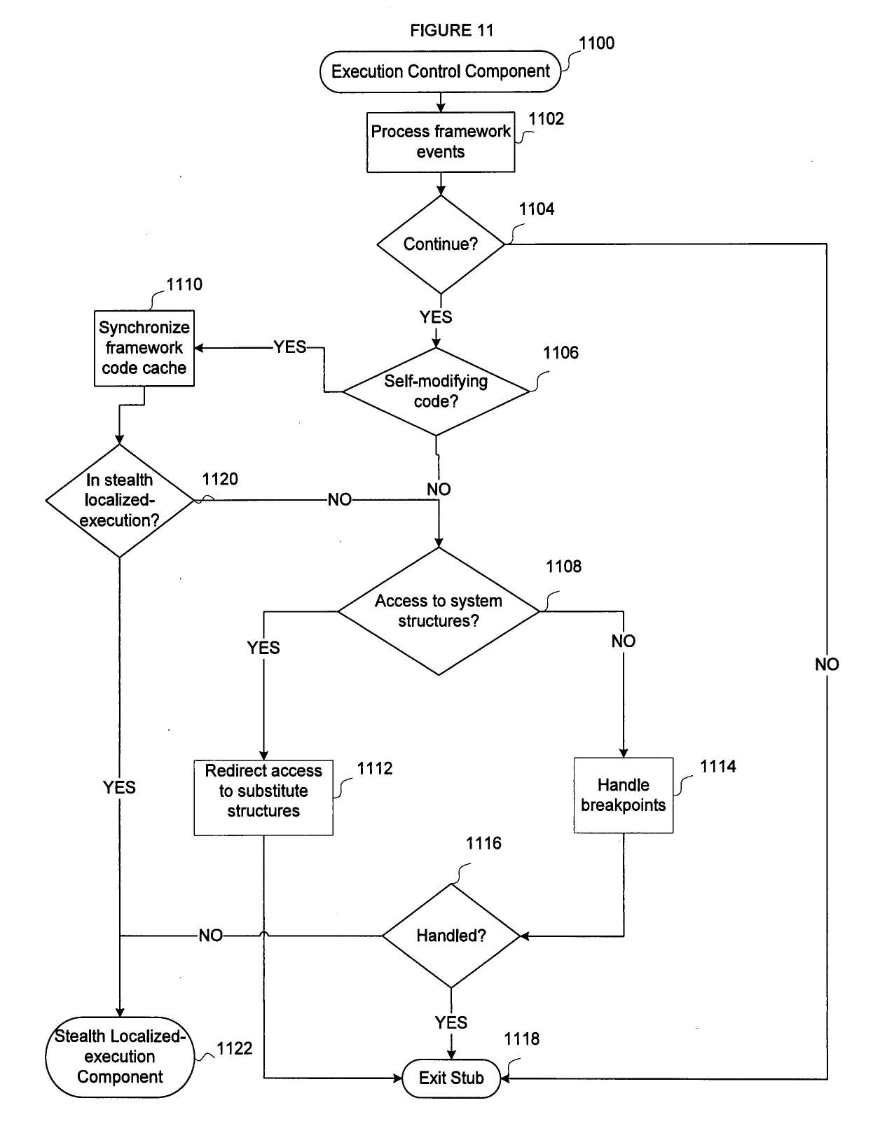

FIG. 11 is a flow diagram that illustrates the processing of the execution control component, according to some embodiments. By way of example, the execution control component is invoked on any access to the system structure for execution purposes via the entry stub component. In block 1102, the execution control component processes any events related to its invocation. For example, a malware analyst can setup a event handler that can get control whenever there is a privilege level switch in the system. In block 1104, the execution control component determines if it has to continue processing or exit depending upon the return value of the event handler in block 1102. If there is an exit, the execution control component transfers control back to the code via the exit stub component in block 1118. If not, the execution control component in block 1106 checks to see if there are any modifications to the code regions which already have blocks constructed for by the stealth localized-execution component. For example, during the operation of the stealth localized-execution component, the code memory regions can be setup to generate a page-fault on write. The page-fault destination address can be computed at this point to check if it belongs to a code which has a block. If in block 1106, the execution control component determines a write to a code having a block, it then deletes the corresponding block in block 1110 else it transfers control to block 1108. For example, the deletion of the block can be done on a data store in memory used to hold the blocks. In block 1120 the execution control component checks if the stealth localized-execution component is currently operating. For example, this can be done by checking a memory flag. If so it handles control over to the stealth localized-execution component to continue its processing in block 1122, else it transfers control to block 1108. In block 1108 the execution control component determines if there are any modifications to the system structures. For example, during the operation of the stealth localized-execution component, the memory regions corresponding to the system structures can be setup to generate a page-fault on read or write. The page-fault destination address can be computed at this point to check if it an access to a system structure. If so, the execution control component in block 1112 performs this access on the substitute system structures instead of the original else it transfers control to block 1114. For example, it can use the stealth single step component to execute the instruction performing the access such that the effective address of the instruction is changed to the substitute system structures instead of the original. The execution control component then resumes execution of the code via the exit stub component in block 1118. In block 1114, the execution control component determines if there is an access that needs to trigger a breakpoint. For example, it can transfer control to the stealth breakpoint component to handle the processing. In block 1116 the execution control component then determines if a breakpoint was handled and if so transfers control to the code via the exit stub in block 1118. If not, in block 1122 it starts executing the code using the stealth localized-execution component. For example, kernel-mode code will always have to run in the unprivileged mode.

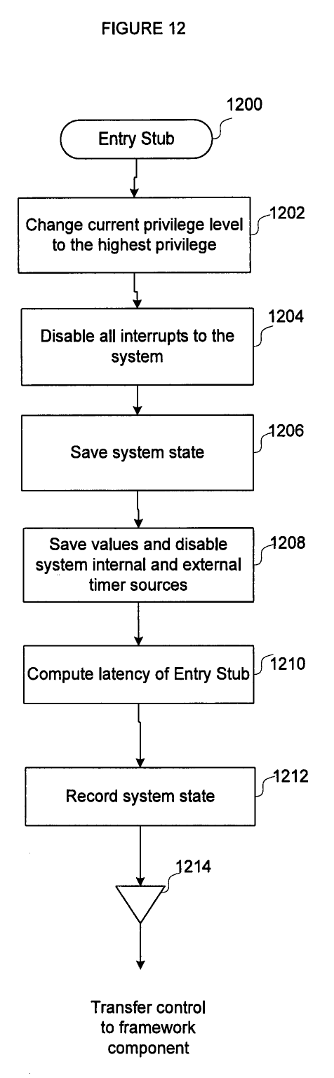

FIG. 12 is a flow diagram that illustrates the processing of the entry stub, according to some embodiments. By way of example, the entry stub can be placed in a system structure or can be placed in a framework local code cache. In block 1202, the entry stub component changes the current executing privilege level of the system to the highest privilege level and automatically establishes a privileged temporary data area. For example, on the x86 class of processors the SYSENTER instruction can be used to transfer control to the highest privilege level and to establish a privileged stack automatically. In block 1204, the entry stub component uses a single instruction that disables all hardware and software interrupts that may interrupt current execution. For example, the single processor instruction can be a clear interrupt flag instruction that disables all interrupts to the CPU by clearing a processor internal flag. In block 1206, the entry stub component saves the values of the processor registers commonly used to perform computations on the temporary storage area. For example, processor general purpose registers and flag registers may be saved on the stack using a processor instruction each. In block 1208, the entry stub component captures current contents of the system internal and external timing devices. For example, the internal timer can be a processor time stamp counter that is incremented monotonically as instructions execute. The external timing source can be an interval timer that has the capability to count up or down from a starting value. In block 1210, the entry stub component computes the actual time in the smallest resolution in the system that has elapsed before block 1202 was executed and before a timer was disabled for all the timers both external and internal. For example, this can be done by first calibrating the time taken by the instructions comprising blocks 1202 through 1208 during the framework deployment in terms of clock cycles which may be the smallest resolution on the computer system. In block 1212, the entry stub component saves other processor state apart from timers and general purpose registers and status registers and records the system state before block 1202 executed. For example, the other registers could be processor machine specific registers, memory type range registers etc. In one embodiment, the entry stub component may record the system state in a data store in memory. Finally, in block 1214, the entry stub component transfers control to a framework specific routine. For example, the execution control component uses a entry stub in the system structures in order to gain control on a privilege change.

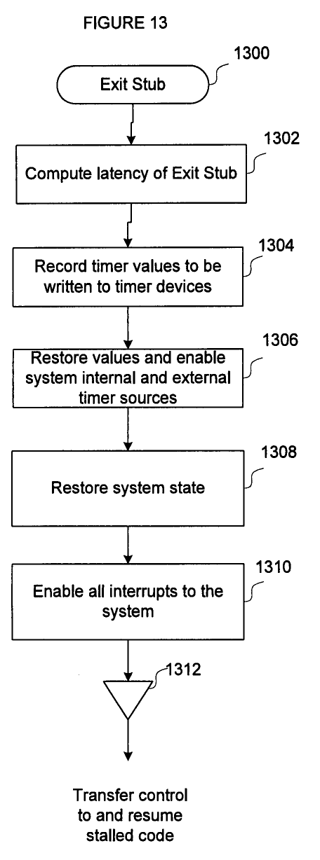

FIG. 13 is a flow diagram that illustrates the processing of the exit stub, according to some embodiments. In block 1302, the exit stub component computes the actual time in the smallest resolution in the system that will elapse after a timer is enabled and before the first instruction of the original code is executed after block 1312. For example, this can be done by first calibrating the time taken by the instructions comprising block 1302 through 1312 during the framework deployment in terms of clock cycles which may be the smallest resolution on the system. In block 1304, the exit stub component records the appropriate contents for the timer values as computed by block 1302. In one embodiment, the exit stub component can use a data store in memory to record the timer values that need to be written back to the timer devices. In block 1306, the exit stub component sets the value of the processor internal timers and other system timers to the recorded values and enables them. For example, the processor internal timer can be a time stamp counter which can be written to using processor specific registers whereas the external timer can be an interval timer which can be written to using I/O instructions. In block 1308, the exit stub component uses a set of instruction to set the processor general purpose registers, status registers and other registers such as machine specific registers and memory type range registers to their original values. For example, the values from the recorded system status can be stored on the stack and processor instructions such as POP to a register can be used for this purpose. In block 1310, the exit stub component uses a single instruction that enables all hardware and software interrupts that may interrupt current execution. For example, the single processor instruction can be a clear interrupt flag instruction that disables all interrupts to the CPU by clearing a processor internal flag. In block 1312, the exit stub component uses a single instruction that does not alter any processor registers or status or the stalled code and transfers control to and resumes from the next instruction in the code. For example, a RET (return) instruction can be used for this purpose.

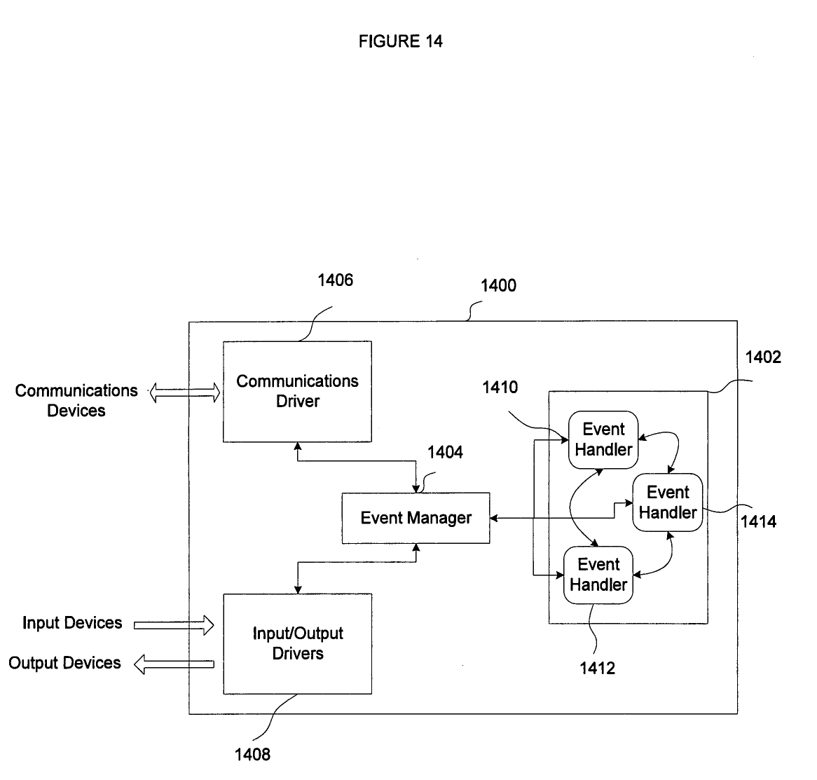

FIG. 14 is a high-level block diagram that illustrates selected components of the local interface component 1400 according to some embodiments. The local interface component comprises a event manager 1404, a event handler execution space 1402, event handlers 1410,1412 and 1414 and a dedicated communication 1406 and input/output drivers 1408 that does not rely on the host operating environment. By way of example, the local interface component can run as a privileged kernel driver within the local computer system. Event handlers are modules that are loaded by the analysts into the local interface component. For example, event handlers can be kernel mode dynamic link libraries. The event handler execution space is a memory region that is only accessible to the local interface component. For example, the local interface component can allocate a pool of memory from the underlying operating environment in kernel mode when it is first deployed. The event manager is responsible for invoking the appropriate event handlers within the event handler execution space when a framework component processes any events on the target computer system. For example, the event manager can invoke a kernel-mode dynamic library export of the event handler. The event manager also allows event handlers to interact with the user on the local system. For example, the output driver can be a video driver and the input driver can be a keyboard driver that directly access the device hardware to present an interface. The event manager also transmits events to a remote interface component. For example, the communications driver is used to transmit packets directly to the remote system without using the host operating environment. The event handlers can also communicate among themselves. For example, a event handler kernel-mode dynamic library can import a function from another event handler kernel-mode dynamic library.

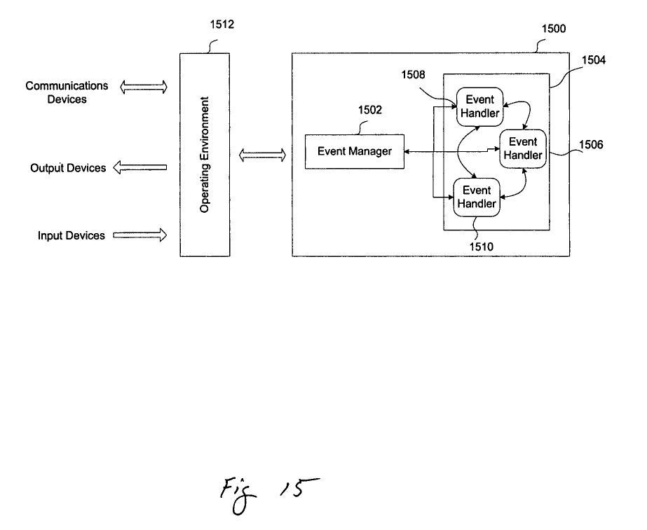

FIG. 15 is a high-level block diagram that illustrates selected components of the remote interface component 1500 according to some embodiments. The remote interface component comprises a event manager 1502, a event handler execution space 1504 and event handlers 1506, 1508 and 1510 and interacts with the operating environment 1512. By way of example, the remote interface component can run as a process within the remote computer system. Event handlers are modules that are loaded by the analysts into the remote interface component. For example, event handlers can be dynamic link libraries. The event handler execution space is a memory region that is only accessible to the remote interface component. For example, the remote interface component can run as a process in which case the event handler execution space is the process address space of the remote interface component. The event manager is responsible for invoking the appropriate event handlers within the event handler execution space when a framework component processes any events on the target computer system. For example, the event manager can listen on the communications link and upon receipt of a event message from the framework can invoke a dynamic library export of the event handler. The event manager also allows event handlers to interact with the user on the remote system and the framework on the target system via the host operating environment. The event handlers can also communicate among themselves. For example, a event handler dynamic library can import a function from another event handler dynamic library or use a message pipe.

Since other modifications and changes varied to fit particular operating requirements and environments will be apparent to those skilled in the art, the invention is not considered limited to the example chosen for purposes of disclosure, and covers all changes and modifications which do not constitute departures from the true spirit and scope of this invention.

What is claimed is:

1. A framework for stealth dynamic coarse and fine-grained malware analysis for creating analysis tools to analyze malware dynamically in both coarse- and fine-grained fashion with complete stealthness, comprising:
means for providing the ability to accurately stall the entire system at any executing privilege level on access to a desired I/O or memory location for read and/or write and/or execute purposes without using any system provided debugging features or modifying memory pertaining to code and/or data being analyzed;
means for enabling access to a breakpoint location from within a breakpoint handling routine without recursively triggering breakpoints and for supporting oneshot (triggered only once), persistent (triggered always) and selectively persistent (triggered once, skipped and retriggered) memory and I/O breakpoints;
means for executing a single instruction either directly using the processor or by emulating its semantics without using any system provided debugging features in a way such that the effect on the system is exactly the same as it would be if the processor would have executed it during normal execution;
means for executing a desired range of a target code such that the instructions comprising the code can be analyzed at any granularity (one instruction to a group of instructions) at any privilege level and such that the execution exactly mimics the normal execution of the code; and
means for ensuring that the framework is always the first to get control and always remain in control no matter what the current privilege level of execution is;

2. The framework for stealth dynamic coarse and fine-grained malware analysis in accordance with claim 1, further comprising:
means for transferring control to the framework during analysis of code in situations which involve handling privileged instructions, breakpoints, dynamically computing the memory address of the next instruction and to process user defined events;
means for creating a group of instructions for analysis such that after the instructions execute, analysis continues with a valid address for creating the next group of instructions in the presence of any form of obfuscation, self-modification or self-checking and the instructions comprising a group has the same effect on the system as they would have, when executed normally;
means for executing a group of instructions during analysis at the unprivileged level such that any attempt to change the system state can be intercepted by the framework.
means for transferring control from an executing code to a framework component at the highest privilege level such that the framework component can execute to completion without any interruption and has access to information that represents the exact state of the system prior to any changes made to the system due to the control transfer; and
means for transferring control back to the stalled code and resuming its execution after a framework component has completed its task such that the state of the system is exactly the same as what it was before the code was stalled;

3. The framework for stealth dynamic coarse and fine-grained malware analysis in accordance with claim 2, further comprising:
means for providing the interface to tools on a computer system where the analysis is not being performed (remote) in order to interact with the computer systems where the analysis is being performed (local), and for managing tools on the remote system in order to process events generated on the local systems and for loading tools into the local systems; and
means for providing the interface to tools on a computer system where the analysis is being performed (local), and for managing tools on the local system in order to process events generated on the local systems and for communicating with a remote system;

4. The framework for stealth dynamic coarse and fine-grained malware analysis in accordance with claims 3, wherein said means for providing the ability to accurately stall the entire system at any executing privilege level on access to a desired I/O or memory location for read and/or write and/or execute purposes without using any system provided debugging features or modifying memory pertaining to code and/or data being analyzed comprises a stealth breakpoint component which includes:
(a) manipulating system structures to trigger breakpoints,
(b) disassembling an instruction performing access and analyzing its operands dynamically to determine read, write or execute breakpoints
(c) processing events to handle breakpoints
(d) triggering system supported breakpoints on the same range of access if needed

5. The framework for stealth dynamic coarse and fine-grained malware analysis in accordance with claims 3, wherein said means for enabling access to a breakpoint location from within a breakpoint handling routine without recursively triggering breakpoints and for supporting oneshot (triggered only once), persistent (triggered always) and selectively persistent (triggered once, skipped and retriggered) memory and I/O breakpoints comprises a stealth breakpoint persistence component which includes:
(a) temporarily modifying the system structures to contain values of the substitute system structures
(b) executing or emulating the instruction causing the breakpoint
(c) restoring the system structures to trigger breakpoints once again.

6. The framework for stealth dynamic coarse and fine-grained malware analysis in accordance with claims 3, wherein said means for executing a single instruction either directly using the processor or by emulating its semantics without using any system provided debugging features in a way such that the effect on the system is exactly the same as it would be if the processor would have executed it during normal execution comprises a stealth single step component which includes:
(a) computing effective address of an instruction without executing it
(b) execute a single instruction by emulating its semantics
(c) execute a single instruction by relocating and directly executing without emulation
(d) handling any exception including system single-stepping as a result of instruction execution
(e) processing user-defined events related to instruction execution

7. The framework for stealth dynamic coarse and fine-grained malware analysis in accordance with claims 3, wherein said means for executing a desired range of a target code such that the instructions comprising the code can be analyzed at any granularity (one instruction to a group of instructions) at any privilege level and such that the execution exactly mimics the normal execution of the code comprises a stealth localized-execution component which includes:
(a) creating a block of instructions from a code such that it can handle any form of code obfuscation
(b) executing a block at an unprivileged level in the framework area while maintaining its semantics according to its original privilege level
(c) executing instructions one at a time if the system is configured by a code to do so, while preserving the semantics of single-step execution as it would have been normally
(d) processing events involving block creations and executions

8. The framework for stealth dynamic coarse and fine-grained malware analysis in accordance with claims 3, wherein said means for ensuring that the framework is always the first to get control and always remain in control no matter what the current privilege level of execution is comprises a execution control component which includes:
(a) detecting access to system structures and redirecting them to substitute system structures
(b) recreating groups of instructions upon detecting self-modification to code
(c) always executing privileged code in an unprivileged level
(d) transferring control to the stealth breakpoint component to handle breakpoints

9. The framework for stealth dynamic coarse and fine-grained malware analysis in accordance with claims 3, wherein said means for transferring control to the framework during analysis of code in situations which involve handling privileged instructions, breakpoints, dynamically computing the memory address of the next instruction and to process user defined events comprises a stealth localized-execution stub which includes:
(a) terminating stealth localized-execution
(b) triggering breakpoints during stealth localized-execution
(c) emulating privileged instructions during stealth localized-execution
(d) processing user-defined events during stealth localized-execution
(e) obtaining a valid memory address to generate a new block and continue stealth localized-execution

10. The framework for stealth dynamic coarse and fine-grained malware analysis in accordance with claims 3, wherein said means for creating a group of instructions for analysis such that after the instructions execute, analysis continues with a valid address for creating the next group of instructions in the presence of any form of obfuscation, self-modification or self-checking and the instructions comprising a group has the same effect on the system as they would have, when executed normally comprises a block create component which includes:
(a) generating and processing appropriate exceptions during creation of blocks from the code
(b) creating a block such that it always terminates on a branch instruction,
(c) inserting stealth localized-execution stubs for privileged instructions, breakpoint locations, legacy i/o instructions and any user-defined instruction events

11. The framework for stealth dynamic coarse and fine-grained malware analysis in accordance with claims 3, wherein said means for executing a group of instructions during analysis at the unprivileged level such that any attempt to change the system state can be intercepted by the framework comprises a block execute component which includes:
(a) setting up an execution environment in order to intercept access/changes to the system state including the executing code and system structures
(b) updating the system state to execute the block

12. The framework for stealth dynamic coarse and fine-grained malware analysis in accordance with claims 3, wherein said means for transferring control from an executing code to a framework component at the highest privilege level such that the framework component can execute to completion without any interruption and has access to information that represents the exact state of the system prior to any changes made to the system due to the control transfer comprises a entry stub which includes:
(a) a control transfer instruction which changes the current privilege level to the highest privilege level and automatically establishes a temporary data area
(b) freezing and saving the system state
(c) computing the latency of the entry stub
(d) recording the system state prior to the entry stub.

13. The framework for stealth dynamic coarse and fine-grained malware analysis in accordance with claims 3, wherein said means for transferring control back to the stalled code and resuming its execution after a framework component has completed its task such that the state of the system is exactly the same as what it was before the code was stalled comprises a exit stub which includes:
(a) computing the latency of the exit stub
(b) restoring the system state prior to the entry implant
(c) transferring control and resuming the stalled code.

14. The framework for stealth dynamic coarse and fine-grained malware analysis in accordance with claims 3, wherein said means for providing the interface to tools on a computer system where the analysis is being performed (local), and for managing tools on the local system in order to process events generated on the local systems and for communicating with a remote system comprises a local interface component which includes:
(a) having a dedicated communication, input and output drivers not using host environment support
(b) loading and unloading event handlers in a event handler address space that is within the framework on a local system
(c) executing the appropriate event handlers in the local system for events generated by the framework
(d) allowing the event handlers to communicate with users on the local or remote system
(e) allowing local system state to be read by a remote system.

15. The framework for stealth dynamic coarse and fine-grained malware analysis in accordance with claims 3, wherein said means for providing the interface to tools on a computer system where the analysis is not being performed (remote) in order to interact with the computer systems where the analysis is being performed (local), and for managing tools on the remote system in order to process events generated on the local systems and for loading tools into the local systems comprises a remote interface component which includes:
(a) loading and unloading event handlers on a remote system within the framework space
(b) executing the appropriate event handlers in the remote system for events generated on a local system
(c) loading event handlers into a local system
(d) allowing the event handlers on a remote system to obtain local system state and to communicate with users on the remote system

16. A framework for stealth dynamic coarse and fine-grained malware analysis for creating analysis tools to analyze malware dynamically in both coarse- and fine-grained fashion with complete stealthness, comprising:
a stealth breakpoint component, for providing the ability to accurately stall the entire system at any executing privilege level on access to a desired I/O or memory location for read and/or write and/or execute purposes without using any system provided debugging features or modifying memory pertaining to code and/or data being analyzed;
a stealth breakpoint persistence component, for enabling access to a breakpoint location from within a breakpoint handling routine without recursively triggering breakpoints and for supporting oneshot (triggered only once), persistent (triggered always) and selectively persistent (triggered once, skipped and retriggered) memory and I/O breakpoints;
a stealth single-step component, for executing a single instruction either directly using the processor or by emulating its semantics without using any system provided debugging features in a way such that the effect on the system is exactly the same as it would be if the processor would have executed it during normal execution;
a stealth localized-execution component, for executing a desired range of a target code such that the instructions comprising the code can be analyzed at any granularity (one instruction to a group of instructions) at any privilege level and such that the execution exactly mimics the normal execution of the code;
a execution control component, for ensuring that the framework is always the first to get control and always remain in control no matter what the current privilege level of execution is;
a stealth localized-execution stub, for transferring control to the framework during analysis of code in situations which involve handling privileged instructions, breakpoints, dynamically computing the memory address of the next instruction and to process user defined events;
a block create component, for creating a group of instructions for analysis such that after the instructions execute, analysis continues with a valid address for creating the next group of instructions in the presence of any form of obfuscation, self-modification or self-checking and the instructions comprising a group has the same effect on the system as they would have, when executed normally;
a block execute component, for executing a group of instructions during analysis at the unprivileged level such that any attempt to change the system state can be intercepted by the framework.
a entry stub, for transferring control from an executing code to a framework component at the highest privilege level such that the framework component can execute to completion without any interruption and has access to information that represents the exact state of the system prior to any changes made to the system due to the control transfer;
a exit stub, for transferring control back to the stalled code and resuming its execution after a framework component has completed its task such that the state of the system is exactly the same as what it was before the code was stalled;
a remote interface component, for providing the interface to tools on a computer system where the analysis is not being performed (remote) in order to interact with the computer systems where the analysis is being performed (local), and for managing tools on the remote system in order to process events generated on the local systems and for loading tools into the local systems;
a local interface component, for providing the interface to tools on a computer system where the analysis is being performed (local), and for managing tools on the local system in order to process events generated on the local systems and for communicating with a remote system.
